(19) United States
(12) Patent Application Publication
(10) Pub. No.: US 2006/0201823 A1
(43) Pub. Date: Sep. 14, 2006

(54) Method and system of electrochemical machining

(76) Inventors: William J. Zdeblick, Ann Arbor, MI (US); Yuliu Zheng, Ann Arbor, MI (US); Ken Bischof, Sylvania, OH (US); Jiancheng Liang, Novi, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/360,290

(22) Filed: Feb. 23, 2006

Related U.S. Application Data
(60) Provisional application No. 60/655,846, filed on Feb. 24, 2005.

(51) Int. Cl. B23H 9/00; C25D 17/00

(52) U.S. Cl. 205/640; 204/224 M

(57) ABSTRACT

An electrochemical machining (ECM) system for machining a workpiece includes a plurality of ECM stations. A first ECM station machines a first region of the workpiece. A second ECM station machines a second region of the workpiece separate from the first region. Additional ECM stations may also be utilized. Each ECM station includes a stationary electrode for delivering electric current for eroding material from the workpiece. Each ECM station also includes an ultrasonic transducer for determining a width of electrolyte between the stationary electrode and the workpiece. Machining of the workpiece in each ECM station is completed when the width of electrolyte reaches a predetermined width.

This invention claims priority to U.S. Provisional Patent Application No. 60/655,846, filed Feb. 24, 2005.

### BACKGROUND OF THE INVENTION

1. Field of the Invention

The subject invention relates generally to an electrochemical machining system for shaping and forming metallic workpieces.

2. Description of the Related Art

Methods and systems for electrochemical machining are well known in the prior art. One example of a multiple station electrochemical machining system is disclosed in U.S. Pat. No. 3,414,501 (the '501 patent).

The system disclosed in the '501 patent machines a continuous strip of razor blade stock. The stock is conveyed through a machining chamber. The chamber includes a series of electrodes immersed in an electrolyte. The electrodes are separated from one another by insulating spacers. The stock passes close to each electrode as it is conveyed through the chamber. An electric current passes through the electrodes, the electrolyte, and the stock, thus eroding a portion of the stock away from one region of the stock.

Although the '501 patent may provide an effective system for machining the one region of the stock to manufacture razor blades, there remains an opportunity to provide an electrochemical machining method and system for machining workpieces with complex machining needs.

### SUMMARY OF THE INVENTION

A method of machining a workpiece according to the invention includes providing an electrochemical machine tool having a plurality of discrete work stations that are each fitted with dedicated electrode tooling of a prescribed shape and size that differs from station to station for performing successive electrochemical machining operations on the workpiece. The workpiece is introduced to a first of the stations and is supported in a fixed relation relative to the electrode of the first station to define a starting gap between the workpiece and the electrode which is caused to widen during the electrochemical machining operation without physical movement of either the workpiece or electrode. The widening of the gap is monitored until the gap reaches a predetermined increased gap condition and thereafter the machining operation is discontinued at the first station. The workpiece is then advanced to at least a second successive ECM station where the process is repeated until such time as a final workpiece size and shape is achieved.

The invention further contemplates an ECM tool which includes a plurality of discrete ECM stations each having a dedicated electrode machine tool of predetermined configuration that differ among the stations and being supported in fixed position during a machining operation. A device is provided for supporting a workpiece to be machined in fixed position at each station relative to the fixed electrode to define a starting gap therebetween which widens during the course of machining at each station.

The invention has the advantage of enabling complex shapes to be electrochemically machined on a workpiece in a step-wise efficient manner.

The invention has the further advantage of carrying out the ECM process using stationary ECM tooling and multiple ECM stations such that a certain amount of machining of a workpiece takes place at one station having fixed ECM tooling, and is then advanced to a subsequent station ECM station or stations at which further machining takes place relative to fixed ECM tooling. In this way, the process avoids the need for movable tooling and reduces the time a workpiece spends at any one station, since only part of the machining is carried out at any one station and can be controlled to optimize efficiency such that the maximum number of workpieces can be cycled through the stations to maximize production rate. By controlling the amount of machining that occurs at any station relative to the fixed ECM tooling, it minimized the time that the fully machined surfaces of a workpiece spend at the first station while awaiting the machining of other regions of the workpiece. Instead, once the desired optimal amount of machining is completed at the first stations, the workpiece is advanced to at least a second station for further machining in the other areas, and then from there to subsequent station(s), if necessary, for additional machining in further regions of the workpiece.

The subject invention also provides an ECM system for machining the workpiece comprising the first ECM station including the first stationary electrode and the electrolyte to form the first gap of electrolyte between the workpiece and the first stationary electrode for eroding material from the first region of the workpiece by passing the electric current through the first stationary electrode, the first gap of electrolyte, and the workpiece. The ECM system also comprises the second ECM station including the second stationary electrode and the electrolyte for forming the second gap of electrolyte between the workpiece and the second stationary electrode for eroding material from a second region of the workpiece, by passing the electric current through the second stationary electrode, the second gap of electrolyte, and the workpiece. The subject invention further comprises a workpiece handling system for moving the workpiece from the first machining station to the second machining station.

The ECM system and method of the present invention allow for more complex electrochemical machining than is available in the prior art. Several portions of the workpiece can be machined to produce elaborate machined parts, such as, but not limited to, pistons, connecting rods, and camshafts.

### BRIEF DESCRIPTION OF THE DRAWINGS

These and other features and advantages of the present invention will become more readily appreciated when considered in connection with the following detailed description and appended drawings, wherein:

FIG. 1 is a perspective view of an electrochemical machining (ECM) system.

FIG. 2A is a cross-sectional view of the first ECM station before a workpiece is machined.

FIG. 2B is a cross-sectional view of the first ECM station after the workpiece is machined.

FIG. 3A is a cross-sectional view of the second ECM station before the workpiece is machined.

FIG. 3B is a cross-sectional view of the second ECM station after the workpiece is machined.

### DETAILED DESCRIPTION OF THE PREFERRED EMBODIMENT

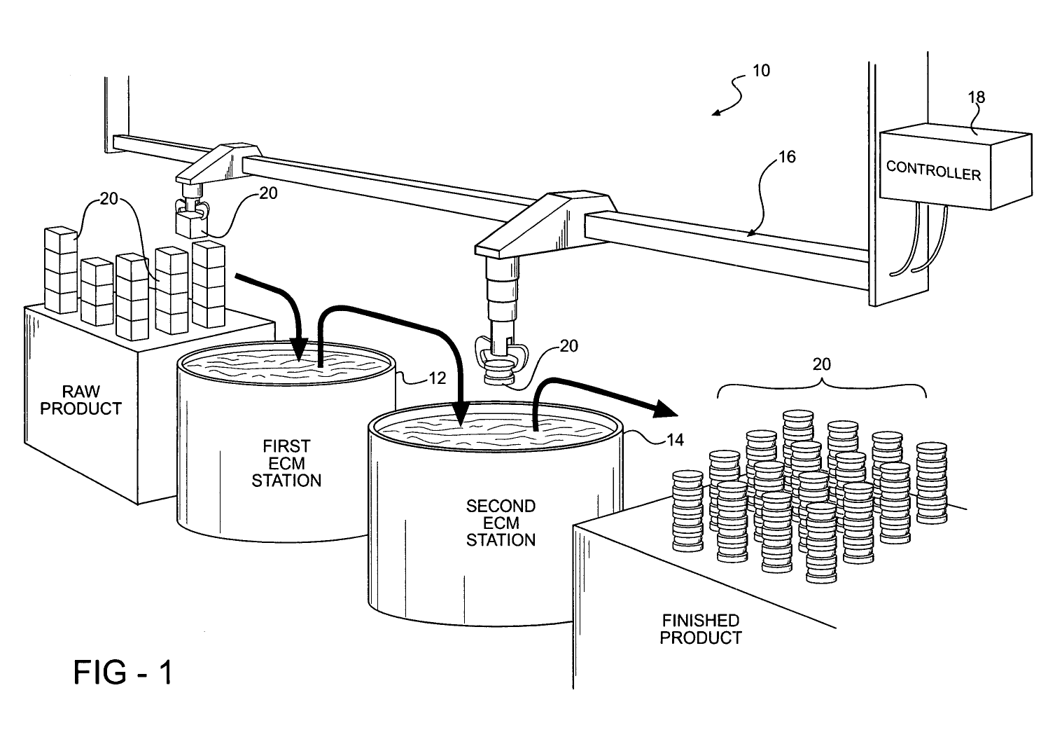

Referring to the Figures, where like numerals indicate like parts throughout the several views, an electrochemical machining (ECM) system for machining a workpiece is shown generally at 10 in FIG. 1. A method of an associated ECM process is also described herein.

The ECM system 10 comprises a plurality of ECM stations numbering at least two, but including three or more stations contemplated by the invention. For purposes of illustration only, the process will be described with respect to two ECM stations, but it is to be understood that the description is applicable to and the invention contemplates having a third, a forth or more ECM stations as may be required by a particular application or workpiece. Referring to the drawings, the system 10 is shown to include a first ECM station 12, a second ECM station 14, and a workpiece handling system 16. Preferably, the workplace handling system 16 is an automated device for moving and manipulating the workpiece into and out of the first and second ECM stations 12, 14 and through other components of the system 10. The workpiece handling system 16 may comprise a robot, a gantry, conveyors, grippers, or other apparatus well know to those skilled in the art. A controller 18 is operatively connected to the workpiece handling system 16 for controlling operation and movement of the workpiece handling system 16.

The ECM stations 12, 14 both function to erode material from the workpiece 20. However, the first ECM station 12 erodes material from a first region of the workpiece 20, while the second ECM station 14 (and any subsequent ECM stations) erodes material from another region of the workpiece 20. The locations of the first and second regions on the workpiece 20 depend on a number of factors, including rough dimensions of the workpiece 20, desired finished dimensions of the workpiece 20, an amount of stock to be removed from the workpiece 20, etc. The first and second regions may be at different positions on the workpiece 20. Alternatively, the first and second regions may be at the same or overlapping positions on the workpiece 20.

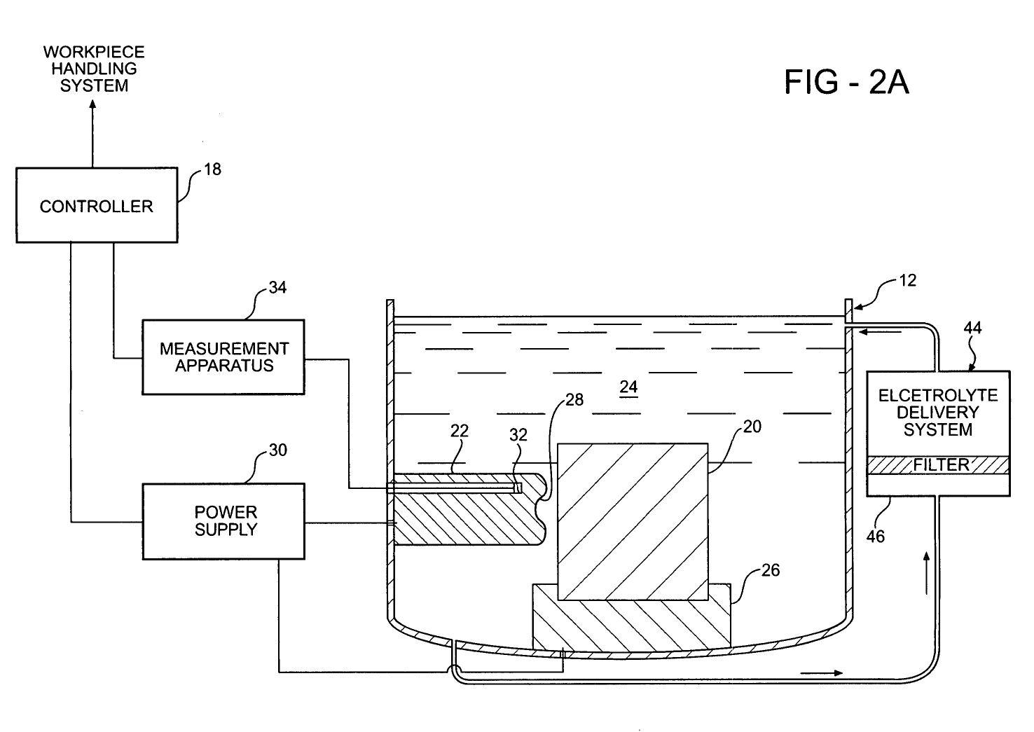

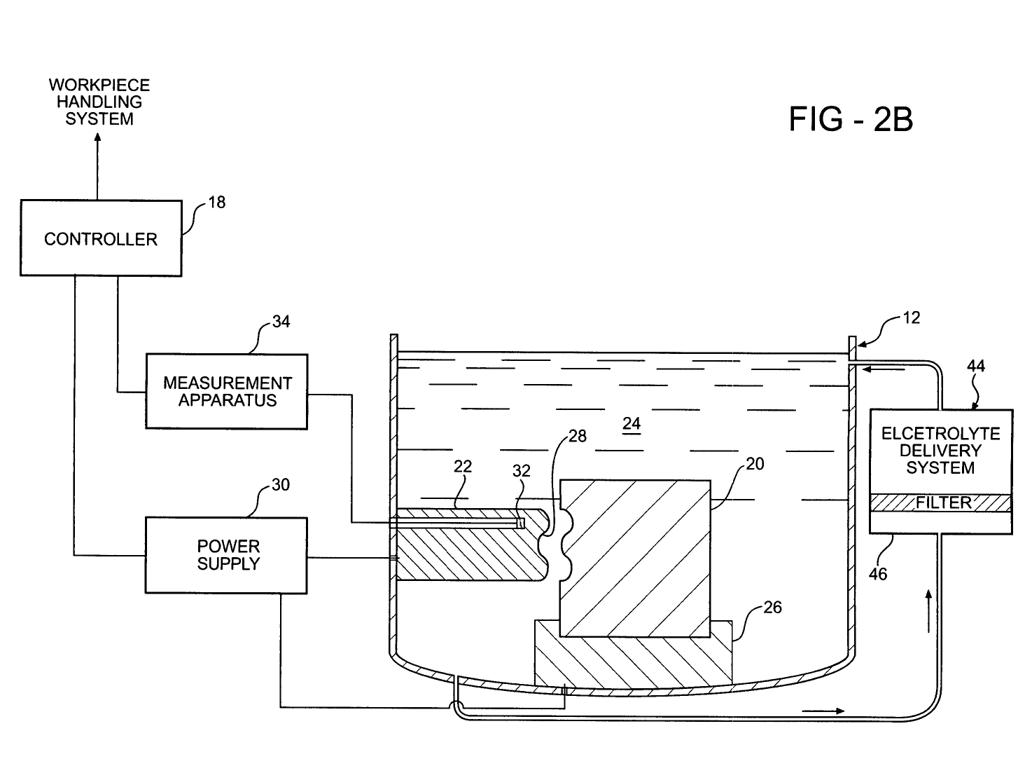

Referring now to FIG. 2A, the first ECM station 12 comprises a first stationary electrode 22 immersed in an electrolyte 24 or flushed with a flow of electrode to be effectively immersed. The position of the first stationary electrode 22 is fixed, meaning the stationary electrode 22 does not move at any time during the ECM process. The first ECM station 12 further comprises a first part holder 26. The first part holder 26 retains the workpiece 20 stationary during the ECM process.

The workpiece handling system 16 moves the workpiece 20 into the first ECM station 12 and places the workpiece 20 in the first part holder 26. The first region of workpiece is immersed (or flushed) in the electrolyte 24. This forms a first gap of electrolyte 28 between the first stationary electrode 22 and the workpiece 20. The gap is maintained at about 50-400 microns.

A power supply 30 is operatively connected to the first stationary electrode 22 and the workpiece 20. In the illustrated embodiment the power supply 30 is electrically connected to the first part holder 26, which is in turn electrically connected to the workpiece 20. The power supply 30 produces electric current that passes through the first stationary electrode 22, the first gap of electrolyte 28, and the workpiece 20. This application of electric current causes material from the first region of the workpiece 20 to be eroded away from the workpiece 20, as shown in FIG. 2B. The electrolyte 24 flows through the first gap of electrolyte 28 to flush the eroded material away.

The first ECM station 12 further includes a first ultrasonic sensor 32 operatively connected to a measurement apparatus 34. The first ultrasonic sensor 32 and measurement apparatus 34 determine the width of the first gap of electrolyte 28. It is preferred that the first ultrasonic sensor 32 is embedded within the first stationary electrode 22. However, those skilled in the art realize that the first ultrasonic sensor 32 may be located in a variety of positions to adequately determine the width of the first gap of electrolyte 28.

The measurement apparatus 34 generates an ultrasonic wave that is transmitted by the first ultrasonic sensor 32. The ultrasonic wave propagates through the first stationary electrode 22 and the first gap of electrolyte 28 to the workpiece 20. The wave reflects off the workpiece 20 and is received by the first ultrasonic sensor 32 and sent back to the measurement apparatus 34. The measurement apparatus 34 then computes the width of the first gap of electrolyte 28 based on the time delay between the sending and receiving of the ultrasonic wave.

This measurement of the first gap of electrolyte 28 is performed continuously during the ECM process. As the electric current is applied and material is eroded from the workpiece, the width of the first gap 28 will increase. The measurement apparatus 34 is operatively connected to the controller 18. The measurement of the first gap 28 is sent to the controller 18 in real-time.

In addition to the workpiece handling system 16 and measurement apparatus 34, the controller 18 is also operatively connected to the power supply 30. The controller 18 sends commands to the power supply 30. These commands are used to turn the power supply 30 on an off and adjust the properties of the electrical current produced by the power supply 30. These properties include voltage, amperage, pulse width, etc. Preferably, the power supply 30 returns feedback of its operation back to the controller 18.

In a first embodiment, the controller 18 analyzes the current measurement of the first gap 28 provided by the measurement apparatus 34. When the first gap 28 of electrolyte reaches a first predetermined width, the controller 18 stops the flow of electric current produced by the power supply 30. Stopping the flow of electric current is accomplished using a switch, relay, or other appropriate device (not shown). The controller 18 than commands the workpiece handling system 16 to remove the workpiece 20 from the first ECM station 12 and transfer the workpiece 20 to the second ECM station 14.

In a second embodiment, the controller also analyzes the current measurement of the first gap 28 provided by the measurement apparatus 34. The workpiece handling system 16 is commanded to remove the workpiece 20 from the first ECM station 12 when the first gap 28 of electrolyte reaches the first predetermined width. The electric current is not stopped, but the electrical circuit is interrupted as the workpiece 20 is removed by the workpiece handling system 16. No switch or relay is required to stop the flow of electric current. The controller 18 then commands the workpiece handling system 16 to transfer the workpiece 20 to the second ECM station 14.

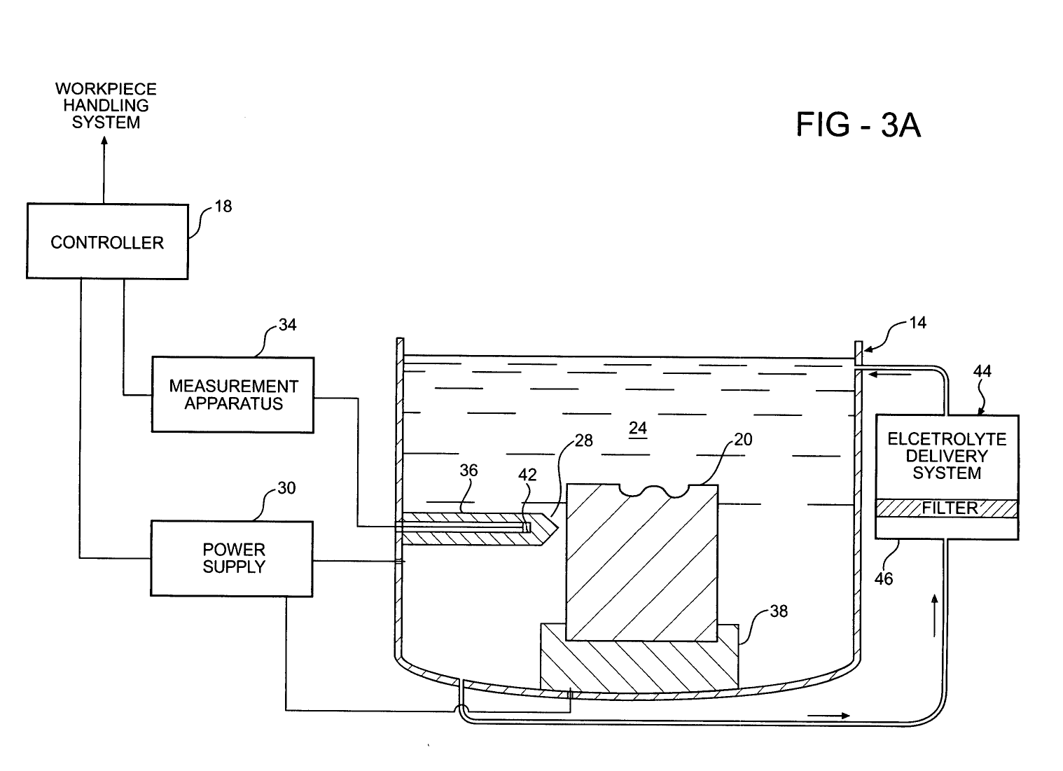

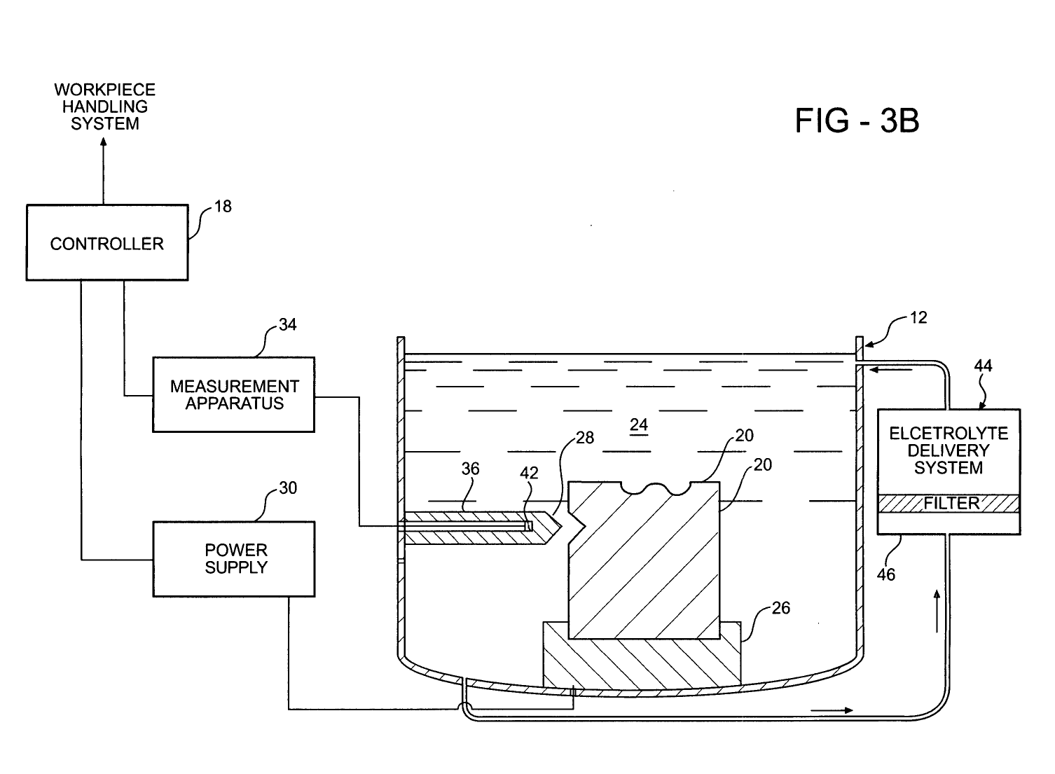

As stated above, the second ECM station 14 functions in a similar manner to the first ECM station 12. Referring now to FIG. 3A, the second ECM station 14 comprises a second stationary electrode 36 and the electrolyte 24. The second ECM station 14 may share the electrolyte 24 from the first ECM station 14, or may have its own separate supply of electrolyte 24. Preferably, the second ECM station 14 also comprises a second part holder 38 to secure the workpiece 20 during the ECM process. A second gap 40 of electrolyte is formed between the workpiece 20 and the second stationary electrode 36 after the workpiece handling system 16 has placed the workpiece 20 in the second part holder 38. A second ultrasonic sensor 42, preferably embedded within the second stationary electrode 36, is operatively connected to the measurement apparatus 34 to determine the width of the second gap 40 of electrolyte. Electric current is applied and material is eroded from a second region of the workpiece 20, as shown in FIG. 3B. An independent power supply or the power supply 30 used in the first ECM station 12 may supply the electric current.

Of course, as mentioned additional ECM stations could also be added to the ECM system 10. Furthermore, additional stationary electrodes could be added to any of the ECM stations. The number of ECM stations and stationary electrodes per ECM station will vary depending on the type, size, and complexity of the machining requirements of the workpiece 20.

The ECM system 10 also comprises at least one electrolyte delivery system 44. The electrolyte delivery system 44 supplies the electrolyte 24 to the first and second ECM stations 12, 14. The electrolyte delivery system 44 includes pumps, hoses, and other related devices to maintain a certain pressure and flow of electrolyte 24 to the ECM stations 12, 14. The electrolyte delivery system 44 also includes at least one electrolyte filtering device 46. The electrolyte filtering device 46 filters material eroded from the workpiece 20 and other debris from the electrolyte 24 while maintaining the temperature, salt concentration, cleanliness, and pH level of the electrolyte 24.

Preferably, the controller 18 is operatively connected to the workpiece handling system 16. This allows the controller to coordinate the machining and moving of the workpiece 20 to maximize throughput of a plurality of workpieces 20 through the ECM system. Accordingly, the ECM system 10 is designed to equalize a first time necessary to erode material from the first region of the workpiece 20 to a second time necessary to erode material from the second region of the workpiece 20.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A method of machining a workpiece, comprising:
providing an electrochemical machine tool having a plurality of work stations each fitted with dedicated electrode tooling of a prescribed shape and size that differs from station to station for performing successive electrochemical machining (ECM) operations on the workpiece;
introducing the workpiece to a first of the plurality stations and supporting the workpiece and the electrode of the first station in fixed relation to one another to define a starting gap between the workpiece and the electrode which widens during the electrochemical machining operation at the first station without physical movement of either the workpiece or electrode;
monitoring the widening gap until the gap reaches a predetermined increased gap condition and thereafter discontinuing the machining operation of the workpiece at the first station;
advancing the workpiece to at least a second successive ECM station where the workpiece and the electrode are supported in fixed relation to one another to define a starting gap between the workpiece and the electrode at the second station which widens during the electrochemical machining operation at the second station without physical movement of either the workpiece or electrode to further machine the workpiece.

2. The method of claim 1 including flowing an electrolyte fluid through the widening gap at the stations during machining.

3. The method of claim 1 wherein each station has its own pulsing and control circuit associated with performing the particular machining step at the given station.

4. The method of claim 1 wherein there are at least three such stations each having the fixed electrode tooling and each machining to achieve a widening gap.

5. The method of claim 1 wherein as a workpiece is moved from one station to the next, another workpiece is introduced to the station in succession.

6. The method of claim 5 including synchronizing the machine cycle times of the plurality of stations.

7. The method of claim 1 wherein each station performs a different machining operation of the workpiece.

8. The method of claim 1 wherein the maximum gap ranges from about 50-400 um.

9. An electrochemical machine tool, comprising:
a plurality of machining stations each having a dedicated electrode machine tool of predetermined configuration that differ among the stations and being supported in fixed position during a machining operation at each station; and
a device for supporting a workpiece to be machined in fixed position at each station relative to the fixed electrode to define a starting gap between the workpiece and electrode which widens during the course of machining at each station.

10. The tool of claim 9 including a flow supply of electrolyte to the electrode regions for introducing a flow of the electrolyte to the gap during machining.

11. The tool of claim 9 including a measuring device for measuring the widening gap between the workpiece and electrode.

12. The tool of claim 11 wherein the measuring device comprises an ultrasonic device.

13. The tool of claim 11 wherein said measuring device comprises a device for measuring changing current across the widening gap.

14. The tool of claim 9 including a system for controlling the pulsing of the electrodes at each station for controlling machining of the workpiece.

15. The tool of claim 9 including a system for synchronizing the machine cycles of the stations.

16. A method of machining a workpiece using a plurality of electrochemical machining (ECM) stations comprising the steps of:
moving the workpiece into a first ECM station to form a first gap of an electrolyte between the workpiece and a first stationary electrode;
machining the workpiece by passing electric current through the first stationary electrode, the first gap of electrolyte, and the workpiece for eroding material from a first region of the workpiece and enlarging the first gap of electrolyte;
moving the workpiece into a second ECM station to form a second gap of the electrolyte between the workpiece and a second stationary electrode;
machining the workpiece by passing electric current through the second stationary electrode, the second gap of the electrolyte, and the workpiece, for eroding material from a second region of the workpiece separate from said first region and enlarging the second gap of the electrolyte.

17. A method as set forth in claim 16 further comprising the step of holding the workpiece stationary in the first ECM station during said machining of the workpiece.

18. A method as set forth in claim 16 further comprising the step of holding the workpiece stationary in the second ECM station during said machining of the workpiece.

19. A method as set forth in claim 16 further comprising the step of determining a width of the first gap of electrolyte.

20. A method as set forth in claim 19 further comprising the step of removing the workpiece from the first ECM station when the first gap of electrolyte reaches a first predetermined width.

21. A method as set forth in claim 19 further comprising the step of stopping the electric current when the first gap of electrolyte reaches a first predetermined width.

22. A method as set forth in claim 21 further comprising the step of removing the workpiece from the first ECM station after the electric current is stopped.

23. A method as set forth in claim 16 further comprising the step of determining a width of the second gap of electrolyte.

24. A method as set forth in claim 23 further comprising the step of removing the workpiece from the second ECM station when the second gap of electrolyte reaches a first predetermined width.

25. A method as set forth in claim 23 further comprising the step of stopping the electric current when the second gap of electrolyte reaches a second predetermined width.

26. A method as set forth in claim 25 further comprising the step of removing the workpiece from the second ECM station after the electric current is stopped.

27. A method as set forth in claim 16 further comprising the step of equalizing a first time necessary to erode material from the first region of the workpiece to a second time necessary to erode material from the second region of the workpiece for maximizing throughput of a plurality of workpieces through the first and second ECM stations.

28. A method as set forth in claim 16 further comprising the step of maintaining a certain pressure and flow of the electrolyte to the first and second ECM stations.

29. A method as set forth in claim 16 further comprising the step of filtering eroded material from the electrolyte.

30. An electrochemical machining (ECM) system for machining a workpiece comprising:
a first ECM station including a first stationary electrode and an electrolyte to form a first gap of electrolyte between the workpiece and said first stationary electrode for eroding material from a first region of the workpiece by passing an electric current through said first stationary electrode, said first gap of electrolyte, and the workpiece;
at least a second ECM station including a second stationary electrode and said electrolyte for forming a second gap of electrolyte between the workpiece and said second stationary electrode for eroding material from a second region of the workpiece, by passing the electric current through said second stationary electrode, said second gap of electrolyte, and the workpiece; and
a workpiece handling system for moving the workpiece from said first machining station to said at least a second machining station.

31. An ECM system as set forth in claim 30 wherein said first ECM station further includes a first part holder for holding the workpiece stationary during the ECM operation.

32. An ECM system as set forth in claim 30 wherein said second ECM station further includes a second part holder for holding the workpiece stationary during the ECM operation.

33. An ECM system as set forth in claim 30 further comprising a first distance sensor for determining a width of said first gap of electrolyte.

34. An ECM system as set forth in claim 33 wherein said first distance sensor is further defined as a first ultrasonic sensor.

35. An ECM system as set forth in claim 34 wherein said first ultrasonic sensor is embedded within said first stationary electrode.

36. An ECM system as set forth in claim 30 further comprising a second distance sensor for determining a width of said second gap of electrolyte.

37. An ECM system as set forth in claim 36 wherein said second distance sensor is further defined as a second ultrasonic sensor.

38. An ECM system as set forth in claim 34 wherein said second ultrasonic sensor is embedded within said second stationary electrode.

39. An ECM system as set forth in claim 30 further comprising at least one power supply operatively connected to said first stationary electrode, said second stationary electrode, and the workpiece for producing said electric current.

40. An ECM system as set forth in claim 39 further comprising a controller operatively connected to said at least one power supply for controlling the application of said first and second electric currents.

41. An ECM system as set forth in claim 31 wherein said controller is operatively connected to said workpiece handling system for coordinating the machining and moving of the workpiece to maximize throughput of a plurality of workpieces through the ECM system.

42. An ECM system as set forth in claim 30 further comprising at least one electrolyte delivery system for supplying said electrolyte to said first ECM station and said second ECM station.

43. An ECM system as set forth in claim 30 further comprising at least one electrolyte-filtering device for filtering debris from said electrolyte and maintaining temperature, salt concentration, cleanliness, and pH level of said electrolyte.
